(19) United States
(12) Patent Application Publication
(10) Pub. No.: US 2006/0271413 A1
(43) Pub. Date: Nov. 30, 2006

(54) Systems and methods for providing deferred compensation to non-profit employees

(76) Inventor: Blake A. Smith, Mound, MN (US)

Correspondence Address: MERCHANT & GOULD PC, P.O. BOX 2903, MINNEAPOLIS, MN, 55402-0903, US

(21) Appl. No.: 11/142,810

(22) Filed: May 31, 2005

(51) Int. Cl. G06Q 40/00

(52) U.S. Cl. 705/4

(57) ABSTRACT

The invention relates to systems and methods for providing deferred compensation to employees of non-profit business entities. By way of example, the invention includes a method of providing deferred compensation from a business entity to an employee including purchasing a life insurance policy on the life of the employee; accelerating the payment of all premiums for the life of the policy into a first time period; and transferring rights in the policy to the employee after the end of the first time period thereby providing deferred compensation.

### FIELD OF THE INVENTION

The invention relates to systems and methods for providing deferred compensation to employees. More specifically, the invention relates to systems and methods for providing deferred compensation to employees of non-profit business entities.

### BACKGROUND OF THE INVENTION

Business organizations have a need to adequately compensate their employees. Adequate compensation helps to retain employees and reduce turnover. One component of total compensation is deferred compensation. Deferred compensation can be defined as an award made by an employer to compensate an employee in a future cost accounting period for services rendered in one or more cost accounting periods before the date of the receipt of compensation by the employee. Deferred compensation is frequently highly valued by employees because it may not generate a tax liability for the employee until a future point in time.

A common form of deferred compensation is retirement benefits, such as retirement or pension plans. Many employers offer qualified retirement plans to their employees as a means of supplementing the employee's total compensation. The term “qualified retirement plan” refers to a retirement plan that meets certain criteria defined in the Internal Revenue Code (IRC). See, e.g., IRC §401(a). A common example of a qualified retirement plan is a 401(k) plan. Qualified retirement plans have various tax advantages for both the employer and the employee. However, because of the criteria set by the IRC, there are limitations on how qualified retirement plans can be used to compensate key employees and executives. Specifically, qualified plans cannot be used to favor certain classes of employees over others. By way of example, qualified plans cannot provide benefits to “highly compensated” employees to the exclusion of other classes of employees. The term “highly compensated” is defined in IRC §414(q). Further, as a result of caps on the total amount of money that can be contributed to qualified plans per employee per year, qualified plans generally make up a much smaller percentage of total compensation for highly compensated employees than for other employees.

Non-profit (or not-for-profit) business entities have a need to adequately compensate their key employees and executives just as for-profit business entities do. There are qualified deferred compensation plans crafted specifically for non-profit business entities. An example is a 403(b) plan. However, just as with qualified plans for other business entities, there are deferral limits with 403(b) plans. As a result, just as in the for-profit context, highly compensated employees of non-profits can only defer a smaller percentage of their income in comparison with other employee classes.

Unfortunately, there are additional reasons that put non-profit employees at a disadvantage compared to their for-profit peers with respect to compensation, retirement, and pension plans. Specifically, non-profit executives do not have the same opportunities for capital accumulation as their for-profit counterparts through vehicles such as stock options, company ownership, etc.

Therefore, a need exists for systems and methods of providing deferred compensation to employees of non-profit business entities.

### SUMMARY OF THE INVENTION

The invention includes systems and methods for providing deferred compensation to employees of non-profit business entities. In an embodiment, the invention includes a method of providing deferred compensation from a business entity to an employee including purchasing a life insurance policy on the life of the employee; accelerating the payment of all premiums for the life of the policy into a first time period; and transferring the rights in the policy to the employee after the end of the first time period thereby providing deferred compensation.

In an embodiment, the invention is a method of providing deferred compensation from a business entity to an employee including purchasing a life insurance policy on the life of the employee for the benefit of the employee, the life insurance policy having a substantial risk of forfeiture; paying all premiums for the life of the policy over a first time period; and then removing the substantial risk of forfeiture after the end of the first time period. In an embodiment, the invention is a method of providing deferred compensation from a business entity to an employee including purchasing a life insurance policy on the life of the employee for the benefit of the employee, wherein the employee's rights to benefits under the life insurance policy are forfeited if the employee fails to remain employed by the business entity over a first time period, and then paying all premiums and fees due over the life of the policy during the first time period.

In an embodiment, the invention is a deferred compensation system including a contract for life insurance on the life of an employee of a business entity, wherein all premiums and fees for the life insurance are payable over a first time period, wherein the employee's rights under the contract are forfeited if the employee fails to remain employed by the business entity over the first time period, wherein the first time period is from about 1 year to about 10 years.

In an embodiment, the invention includes a method of providing deferred compensation to an employee including purchasing a life insurance policy on the life of the employee for the benefit of the employee, wherein the employee's rights to benefits under the life insurance policy are forfeited if the employee fails to remain employed by the business entity over a first time period, wherein the life insurance policy has a fair market value, and finally minimizing the fair market value of the life insurance policy before the end of the first period of time.

The above summary of the present invention is not intended to describe each discussed embodiment of the present invention. This is the purpose of the figures and the detailed description that follows.

### BRIEF DESCRIPTION OF THE FIGURES

The invention may be more completely understood in connection with the following figures, in which:

FIG. 1 is a graph showing values of a deferred compensation plan over time.

It should be understood that the invention is not limited to the particular embodiments described herein. On the contrary, the intention is to cover modifications, equivalents, and alternatives falling within the spirit and scope of the invention.

### DETAILED DESCRIPTION OF THE INVENTION

As with all business entities, non-profit business entities have a need to adequately compensate their employees. Adequate total compensation helps to retain employees and reduce turnover, motivates employees, boosts morale, and allows employees to focus on their duties. One component of total compensation is deferred compensation. Deferred compensation can be highly valued by the employee because in many instances it does not generate a tax liability for the employee until the benefits of the deferred compensation are actually received by the employee at a future point in time.

A common form of deferred compensation is retirement benefits, such as retirement or pension plans. Many non-profit business entities offer qualified deferred compensation plans to their employees as a means of supplementing the employee's total compensation. The term “qualified deferred compensation plan” refers to a plan that meets certain criteria defined by the Internal Revenue Code (IRC). See, e.g., IRC §401(a). The term “non-profit entity” as used herein refers to entities that qualify for treatment as non-profit entities under the Internal Revenue Code.

Rules Governing Deferred Compensation Plans

Because of certain criteria set by the IRC, there are limitations on how qualified retirement plans can be used to compensate key employees and executives. Specifically, qualified plans cannot be used to favor certain classes of employees over others. By way of example, qualified plans cannot provide benefits to “highly compensated” employees to the exclusion of other classes of employees. Further, as a result of caps on the total amount of money that can be contributed to qualified plans per employee per year, qualified plans are, at best, a much smaller percentage of total compensation for high-income employees. To make matters worse in the non-profit context, non-profit employees do not have the same opportunities for capital accumulation as their for-profit counterparts through financial vehicles such as stock options, company ownership, etc. Thus, non-profit employees are at a disadvantage and there is a need to remedy the situation.

Non-qualified deferred compensation plans can also be used to provide deferred compensation to employees. Non-qualified plans are those plans that do not meet the criteria defined in the IRC for qualified plans. Non-qualified deferred compensation plans allow the employer and the highly compensated employee to contribute and accumulate savings in a plan that can be provided to key employees without having to include other employee classes. Thus, the employer can pick and choose from among employees and benefit only a select few. However, as a result of not meeting the criteria defined in the IRC for qualified plans, non-qualified plans may not have some of the tax benefits afforded qualified retirement plans for the employer and/or the employee. While non-profit business entities are generally not concerned with receiving tax deductions, the tax implications for the employee receiving the non-qualified plan are almost always of great importance.

The assets underlying non-qualified deferred compensation plans may be put into various investment vehicles. By way of example, the assets underlying a non-qualified deferred compensation plan may be put into a life insurance policy, such as a universal life insurance policy. Advantageously, where the deferred compensation assets are put into a life insurance product, the assets within the deferred compensation plan can grow on a tax-deferred basis provided certain conditions are met.

The IRC provides special rules for non-qualified deferred compensation plans in the non-profit context under §457 of the Internal Revenue Code. IRC §457(b) provides eligibility requirements for plans that wish to provide recipients with the tax-treatment of deferred compensation plans described in IRC §457(a). Notably, IRC §457(b) specifies a maximum amount that may be deferred under the plan in a given tax year.

IRC §457(f) deals with the tax-treatment of deferred compensation plans that do not comply with the eligibility requirements of §457(b). Specifically, IRC §457(f) provides in relevant part that the deferred compensation shall be included in the gross income of the participant or beneficiary for the first taxable year in which there is no substantial risk of forfeiture of the rights to such deferred compensation. According to IRC §457(f)(3)(B), the rights of a person to compensation are subject to a substantial risk of forfeiture if the person's rights to such compensation are conditioned upon the future performance of substantial services by any individual. Thus, participants in plans that fall under §457(f) must include the deferred compensation in their gross income for purposes of taxation when there is no longer a substantial risk of forfeiture.

Taxation of the non-qualifying deferred compensation plan at the time when a substantial risk of forfeiture no longer applies is an important part of the overall attractiveness of the deferred compensation plan. The amount which must be reported as gross income when a substantial risk of forfeiture no longer exists is calculated based on the “fair market value” of the deferred compensation plan. In the context of life insurance products, the IRS has provided guidance on how to calculate fair market value. Specifically, IRS revenue procedure 2004-16, 26 C.F.R. §601.201, provides that cash value (without reduction for surrender charges) may be treated as the “fair market value” of a contract as of a determination date provided that the cash value is at least as large as the aggregate of: (1) the premiums paid from the date of issue through the date of determination, plus (2) any amounts credited (or otherwise made available) to the policyholder with respect to those premiums, including interest, dividends, and similar income items (whether under contract or otherwise), minus (3) reasonable mortality charges and reasonable charges (other than mortality charges), but only if those charges are actually charged on or before the date of determination and are expected to be paid. Thus, so long as cash value is calculated according to this formula, it will be deemed proper under the IRC.

### Methods and Systems of the Invention

In view of these rules governing non-qualified deferred compensation plans in the non-profit context, Applicants have developed systems and methods of providing deferred compensation to non-profit employees. As discussed above, after the substantial risk of forfeiture is removed, the employee must pay income taxes on the fair market value of the insurance policy in the deferred compensation plan. However, accelerating the charges and premiums for the policy into the time period before the substantial risk of forfeiture expires can lessen the fair market value of the policy. Thus, in some methods of the invention, the amount of money that must be added to the gross income of the employee at the time that the substantial risk of forfeiture expires is minimized by paying all premiums and fees that will be due over the entire life of the policy before that time. An example of how this works is provided below in Example 1. As a result, the employee receiving deferred compensation in accordance with embodiments of the invention can pay less in income taxes than if he/she had simply received the money outright or in accordance with other non-qualified deferred compensation plans.

In an embodiment, the invention includes a method of providing deferred compensation from a business entity to an employee including purchasing a life insurance policy on the life of the employee; accelerating the payment of all premiums and expenses for the life of the policy into a first period of time before the substantial risk of forfeiture is removed; and then removing the substantial risk of forfeiture.

The assets of the deferred compensation plan include a life insurance policy. Life insurance policies (contracts) are as defined in IRC §7702. Life insurance policies in accord with embodiments of the invention generally have an investment component. Exemplary life insurance policies include whole life policies, universal life policies, variable life policies, variable universal life policies, cash value policies, or the like. In a particular embodiment, the life insurance policy is a universal life policy. The assets of the deferred compensation plan could also include products similar to life insurance.

Life insurance polices that exceed certain maximum premium levels during the first seven years become Modified Endowment Contracts (MEC) for purposes of treatment under the IRC. The maximum funding level for a policy without it becoming a MEC can be referred to as the 7-pay premium level. MEC contracts can be undesirable because certain limitations apply to MEC contracts that do not apply to non-MEC policies. As an example, withdrawals of cash value from MEC contracts are on a ‘LIFO’ basis, where earnings are withdrawn first and taxed as ordinary income. In an embodiment of the invention, the life insurance policy serving as the asset of the deferred compensation plan is a non-MEC policy. In an embodiment, the premiums for the life insurance policy serving as the asset of the deferred compensation plan are less than or equal to the 7-pay premium level.

The period of time into which all the payments for the policy are accelerated is generally shorter than or equal to the period of time in which a substantial risk of forfeiture exists for the employee. In an embodiment, the payments are made over a period of time less than about 10 years. The payments may be made over a period of time ranging from 1 to 10 years. In a particular embodiment, the payments are made over five years.

The plan may not be desirable for participants if the substantial risk of forfeiture lasts for too long. In an embodiment, the substantial risk of forfeiture lasts for a period of time less than about 10 years. In an embodiment, the substantial risk of forfeiture lasts for a period of time from about 1 year to about 10 years. In a particular embodiment, the substantial risk of forfeiture lasts for a period of time of about five years. In an embodiment, the substantial risk of forfeiture time period expires after all of the payments for the policy are made.

According to IRC §457(f)(3)(B), the rights of a person to compensation are subject to a substantial risk of forfeiture if such person's rights to such compensation are conditioned upon the future performance of substantial services by any individual. In some embodiments, substantial services for purposes of the substantial risk of forfeiture may constitute full-time employment. However, substantial services for purposes of the substantial risk of forfeiture could also constitute less than full-time employment.

It will be appreciated that the substantial risk of forfeiture may be implemented in various ways. In some embodiments, the substantial risk of forfeiture terms may be written into the life insurance contract. As a further example, the substantial risk of forfeiture terms may be written into a contract for employment. The substantial risk of forfeiture terms may also be written into a vesting agreement.

Deferred compensation plans as described herein can also be paired with additional financial vehicles sufficient to pay for the income taxes generated by the deferred compensation plans. For example, additional salary deferrals accumulating outside of a life insurance contract could be part of the plan so that an amount of money that is sufficient to pay for the additional income tax obligation generated by the deferred compensation plan of the invention is provided in the year that the substantial risk of forfeiture expires. Such additional financial vehicles could take various forms including present compensation, deferred compensation, bonuses, etc. As a specific example, if the substantial risk of forfeiture of a given deferred compensation plan expires after five years and generates an income tax liability of $20,000 for the employee, then another financial vehicle could be added to the plan that generates income after taxes of $20,000 in the same year to cover the $20,000 income tax liability that is due.

Systems and methods of the invention can be more fully understood with reference to the following examples. However, one of skill in the art will appreciate that the examples do not serve to limit the scope of the invention.

### EXAMPLES

### Example 1

### 5-Year Deferred Compensation Plan for 45 Year-Old Employee

Company A is a non-profit business entity that is exempt from taxation under IRC §501(a). Company A employs Employee B (“B”) and desires to use a deferred compensation plan to increase the total compensation of B. Company A contracts with an insurance company to purchase a universal life insurance policy on the life of B. A substantial risk of forfeiture exists with respect to B's rights to the benefits of the policy because his rights are conditioned upon the future performance of substantial services by him. In this case, B must remain employed with Company A full-time for at least five years from the date the policy is purchased or else his rights in the policy will be forfeited. At the end of five years, the substantial risk of forfeiture expires. In this case, Company A transfers all rights to B after five years.

Under the policy, charges and premiums are accelerated to be due during the first five years. Company A pays $50,000 per year to the insurance company for five years to cover the charges and premiums due on the policy. The Policy Year; Age of Insured; Annual Payments; Death Benefit; Policy Value; and Withdrawals and Loans are shown below in Table 1.

TABLE 1

| | Age of | | | | | Surrender |
|---|---|---|---|---|---|---|
| Year | Employee | Payments | Death Benefit | Policy Value | Withdrawals | Value |
| 1 | 46 | 50000 | 891902 | 17787 | 0 | 17787 |
| 2 | 47 | 50000 | 891902 | 36095 | 0 | 36095 |
| 3 | 48 | 50000 | 891902 | 72276 | 0 | 72276 |
| 4 | 49 | 50000 | 891902 | 109860 | 0 | 109860 |
| 5 | 50 | 50000 | 891902 | 148910 | 0 | 148910 |
| 6 | 51 | 0 | 891902 | 154187 | 0 | 154187 |
| 7 | 52 | 0 | 891902 | 159604 | 0 | 159604 |
| 8 | 53 | 0 | 891902 | 166748 | 0 | 166748 |
| 9 | 54 | 0 | 891902 | 174165 | 0 | 174165 |
| 10 | 55 | 0 | 891902 | 181856 | 0 | 181856 |
| 11 | 56 | 0 | 535141 | 190504 | 0 | 190504 |
| 12 | 57 | 0 | 535141 | 199546 | 0 | 199546 |
| 13 | 58 | 0 | 535141 | 209004 | 0 | 209004 |
| 14 | 59 | 0 | 535141 | 218902 | 0 | 218902 |
| 15 | 60 | 0 | 535141 | 266030 | 0 | 266030 |
| 16 | 61 | 0 | 535141 | 285411 | 0 | 285411 |
| 17 | 62 | 0 | 550739 | 306255 | 0 | 306255 |
| 18 | 63 | 0 | 576706 | 328588 | 0 | 328588 |
| 19 | 64 | 0 | 604113 | 352498 | 0 | 352498 |
| 20 | 65 | 0 | 589686 | 352177 | 25888 | 352177 |
| 21 | 66 | 0 | 561716 | 343137 | 25888 | 343137 |
| 22 | 67 | 0 | 534242 | 333609 | 25888 | 333609 |
| 23 | 68 | 0 | 507142 | 323576 | 25888 | 323576 |
| 24 | 69 | 0 | 480425 | 313021 | 25888 | 313021 |
| 25 | 70 | 0 | 457584 | 308340 | 25888 | 301922 |
| 26 | 71 | 0 | 443193 | 322743 | 25888 | 290245 |
| 27 | 72 | 0 | 428075 | 337185 | 25888 | 277825 |
| 28 | 73 | 0 | 411878 | 351639 | 25888 | 264612 |
| 29 | 74 | 0 | 394634 | 366071 | 25888 | 250548 |
| 30 | 75 | 0 | 376346 | 380453 | 25888 | 235579 |
| 31 | 76 | 0 | 357027 | 394756 | 25888 | 219652 |
| 32 | 77 | 0 | 336569 | 408958 | 25888 | 202717 |
| 33 | 78 | 0 | 314895 | 423037 | 25888 | 184727 |
| 34 | 79 | 0 | 292009 | 436976 | 25888 | 165635 |
| 35 | 80 | 0 | 267812 | 450750 | 25888 | 145388 |
| 36 | 81 | 0 | 242234 | 464325 | 25888 | 123923 |
| 37 | 82 | 0 | 215285 | 477664 | 25888 | 101171 |
| 38 | 83 | 0 | 186875 | 490717 | 25888 | 77052 |
| 39 | 84 | 0 | 157154 | 503434 | 25888 | 51483 |
| 40 | 85 | 0 | 151825 | 515767 | 0 | 50270 |
| 41 | 86 | 0 | 146429 | 528256 | 0 | 48807 |
| 42 | 87 | 0 | 140938 | 540910 | 0 | 47091 |
| 43 | 88 | 0 | 135324 | 553740 | 0 | 45120 |
| 44 | 89 | 0 | 129439 | 566759 | 0 | 42895 |
| 45 | 90 | 0 | 123188 | 579989 | 0 | 40423 |
| 46 | 91 | 0 | 116469 | 593455 | 0 | 37717 |
| 47 | 92 | 0 | 109173 | 607187 | 0 | 34792 |
| 48 | 93 | 0 | 101061 | 621221 | 0 | 31671 |
| 49 | 94 | 0 | 92008 | 635605 | 0 | 28384 |
| 50 | 95 | 0 | 81792 | 650370 | 0 | 24950 |
| 51 | 96 | 0 | 70350 | 665532 | 0 | 21367 |
| 52 | 97 | 0 | 57642 | 681068 | 0 | 17595 |
| 53 | 98 | 0 | 43733 | 696915 | 0 | 13557 |
| 54 | 99 | 0 | 28102 | 713045 | 0 | 9206 |
| 55 | 100 | 0 | 5018 | 729953 | 0 | 5018 |

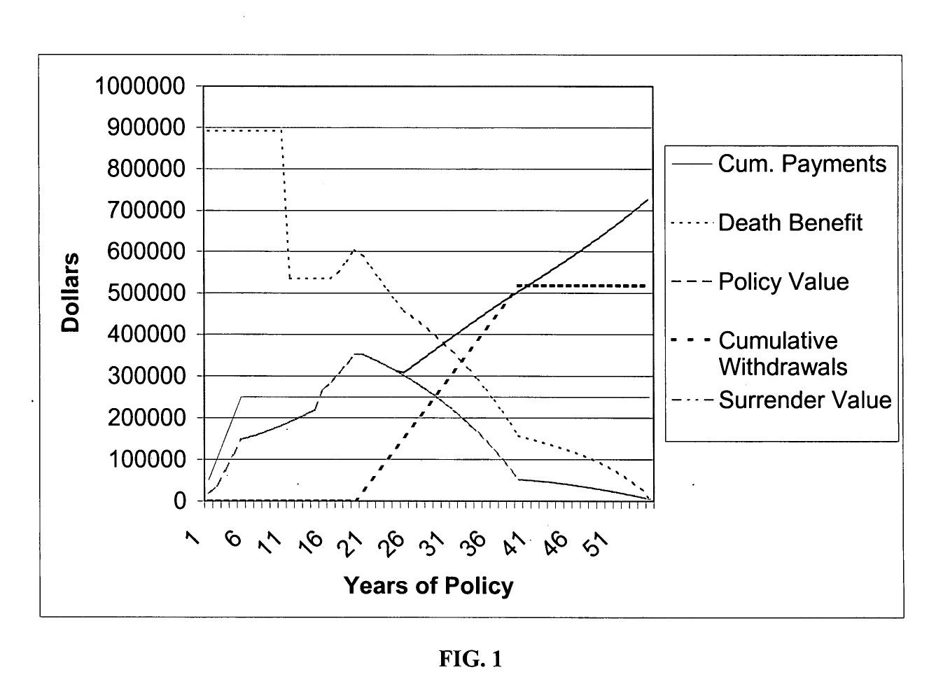

Cumulative Payments, Death Benefit, Policy Value, and Cumulative Withdrawal and Loans for this example are shown in FIG. 1. As can be seen in FIG. 1, under this deferred compensation plan, B enjoys a substantial death benefit starting immediately that gradually drops after about ten years and declines slowly thereafter. In addition, since there is a substantial policy value when B reaches the age of 65, he/she can take money out of the policy over time as a form of retirement income for many years.

In accord with provisions of the IRC, the fair market value of the policy must be added to the gross income of B when a substantial risk of forfeiture no longer exists, in this case after five years. The fair market value is calculated as the aggregate of: (1) the premiums paid from the date of issue through the date of determination, plus (2) any amounts credited, including interest, dividends, and similar income items, minus (3) reasonable mortality charges and other reasonable charges.

In this case, the total premiums paid into the plan over the first five years are in the sum of $250,000. After adding amounts credited and subtracting reasonable charges, the fair market value is calculated to be about $148,910. As a result of the premiums and other fees and charges being accelerated into the first five years, the fair market value is only about 59.5% of the amount of money put into the plan by Company A. Therefore, instead of B paying income taxes on $50,000 per year for five years ($250,000), B pays income taxes on $148,910 at the end of five years. Assuming a marginal tax rate of 33% on this income, B pays income tax of about $49,140, instead of $82,500. This results in a tax savings for B of $33,360. These numbers are summarized in Table 2 below.

TABLE 2

| | Deferred Plan In Accord | |
|---|---|---|
| | With Embodiment of | Comparison |
| | Invention | Plan |
| Money Paid Into Plan | $250,000 | $250,000 |
| Amount Taxable as Income | $148,910 | $250,000 |
| Tax (at 33%) | $49,140 | $82,500 |

Optionally, the income tax due after five years in this example could be funded via a separate accumulation of additional salary deferrals that occurs outside of the life insurance contract of this example. In this manner, the employee can be provided with cash in year five that is sufficient to pay for the income tax liability ($49,140) generated after the expiration of the substantial risk of forfeiture.

### Specific Embodiments of the Invention

In an embodiment, the invention is a method of providing deferred compensation from a business entity to an employee including purchasing a life insurance policy on the life of the employee for the benefit of the employee, the life insurance policy having a substantial risk of forfeiture; paying all premiums for the life of the policy over a first time period; and removing the substantial risk of forfeiture after the end of the first time period thereby providing deferred compensation.

In an embodiment, the invention is a method of providing deferred compensation from a business entity to an employee including purchasing a life insurance policy on the life of the employee for the benefit of the employee, wherein the employee's rights to benefits under the life insurance policy are forfeited if the employee fails to remain employed by the business entity over a first time period, and paying all premiums and fees due over the life of the policy during the first time period.

In an embodiment, the invention is a deferred compensation system including a contract for universal life insurance on the life of an employee of a business entity, wherein all premiums and fees for the life insurance are payable over a first time period, wherein the employee's rights under the contract are forfeited if the employee fails to remain employed by the business entity over the first time period, wherein the first time period is from about 1 year to about 10 years.

In an embodiment, the invention includes a method of providing deferred compensation to an employee including purchasing a life insurance policy on the life of the employee for the benefit of the employee, wherein the employee's rights to benefits under the life insurance policy are forfeited if the employee fails to remain employed by the business entity over a first time period, wherein the life insurance policy has a fair market value, and minimizing the fair market value of the life insurance policy before the end of the first period of time.

In an embodiment, the invention includes a method of providing deferred compensation from a business entity to an employee including purchasing a life insurance policy on the life of the employee; accelerating the payment of all premiums for the life of the policy into a first time period; and transferring the rights in the policy to the employee after the end of the first time period thereby providing deferred compensation.

While the present invention has been described with reference to several particular implementations, those skilled in the art will recognize that many changes may be made hereto without departing from the spirit and scope of the present invention.

We claim:

1. A method of providing deferred compensation from a business entity to an employee comprising:
purchasing a life insurance policy on the life of the employee for the benefit of the employee, the life insurance policy having a substantial risk of forfeiture;
paying all premiums for the life of the policy over a first time period; and
removing the substantial risk of forfeiture after the end of the first time period thereby providing deferred compensation.

2. The method of claim 1, wherein the first time period is from about 1 year to about 10 years.

3. The method of claim 1, wherein the first time period is less than 10 years.

4. The method of claim 1, wherein the first time period is about 5 years.

5. The method of claim 1, wherein the business entity is a non-profit business entity.

6. The method of claim 1, further comprising naming the employee as the beneficiary of the life insurance contract.

7. The method of claim 1, wherein the employee is a highly compensated employee.

8. The method of claim 1, wherein the life insurance policy comprises the assets of a non-qualifying deferred compensation plan.

9. The method of claim 1, wherein the life insurance policy comprises a universal life insurance policy.

10. A method of providing deferred compensation from a business entity to an employee comprising:
purchasing a life insurance policy on the life of the employee for the benefit of the employee, wherein the employee's rights to benefits under the life insurance policy are forfeited if the employee fails to remain employed by the business entity over a first time period, and
paying all premiums and fees due over the life of the policy during the first time period.

11. The method of claim 10, wherein the first time period is from about 1 year to about 10 years.

12. The method of claim 10, wherein the first time period is less than 10 years.

13. The method of claim 10, wherein the first time period is about 5 years.

14. The method of claim 10, wherein the business entity is a non-profit business entity.

15. The method of claim 10, further comprising naming the employee as the beneficiary of the life insurance contract.

16. The method of claim 10, wherein the employee is a highly compensated employee.

17. The method of claim 10, wherein the life insurance policy comprises the assets of a non-qualifying deferred compensation plan.

18. The method of claim 10, wherein the life insurance policy comprises a universal life insurance policy.

19. A deferred compensation system comprising:
a contract for universal life insurance on the life of an employee of a business entity, wherein all premiums and fees for the life insurance are payable over a first time period, wherein the employee's rights under the contract are forfeited if the employee fails to remain employed by the business entity over the first time period, wherein the first time period is from about 1 year to about 10 years.

20. The deferred compensation system of claim 19, wherein the first time period is less than 10 years.

21. The deferred compensation system of claim 19, wherein the first time period is about 5 years.

22. The deferred compensation system of claim 19, wherein the business entity is a non-profit business entity.

23. The deferred compensation system of claim 19, further comprising naming the employee as the beneficiary of the life insurance contract.

24. The deferred compensation system of claim 19, wherein the employee is a highly compensated employee.

25. The deferred compensation system of claim 19, wherein the life insurance policy comprises the assets of a non-qualifying deferred compensation plan.

26. The deferred compensation system of claim 19, wherein the life insurance policy comprises a universal life insurance policy.

27. A method of providing deferred compensation comprising:
purchasing a life insurance policy on the life of an individual;
accelerating the payment of all premiums for the life of the policy into a first time period; and
transferring rights in the policy to the individual after the end of the first time period thereby providing deferred compensation.
